(19) United States
(12) Patent Application Publication
(10) Pub. No.: US 2015/0347583 A1
(43) Pub. Date: Dec. 3, 2015

(54) SYSTEM AND METHOD FOR CONFIGURING AND SHARING SEARCH SETTINGS

(71) Applicant: Aravind Musuluri, Johns Creek, GA (US)

(72) Inventor: Aravind Musuluri, Johns Creek, GA (US)

(21) Appl. No.: 14/730,196

(22) Filed: Jun. 3, 2015

Related U.S. Application Data
(60) Provisional application No. 62/006,923, filed on Jun. 3, 2014.

(51) Int. Cl. G06F 17/30; G06F 3/0484; G06F 3/0482

(52) U.S. Cl. CPC G06F 17/30864; G06F 3/0482; G06F 3/04842

(57) ABSTRACT

Systems and methods are provided to specify preferred search service setting in a system is disclosed. Such preferred search service setting may be shared by two or more applications there by alleviating the need to configure preferred search service multiple times by the user.

### CROSS REFERENCE TO RELATED APPLICATION

This application claims priority to U.S. Provisional Application Ser. No. 62/006923 entitled “System And Method For Configuring And Sharing Search Settings” filed on Jun. 3, 2015, which is incorporated herein by reference.

### TECHNICAL FIELD

The present disclosure generally relates to the field of managing settings associated with applications. Particularly, the disclosure relates to a system and method for configuring a user preferred search service provider and sharing the preference across one or more applications of a system.

### BACKGROUND

The statements in this section merely provide background information related to the present disclosure and may not constitute prior art.

A browser installed in a system allows the user to select a preferred search service provider among multiple search service providers. When a user conducts a search operation on a keyword or a phrase from within the browser, the browser delegates the search operation to the user preferred search service provider.

Similarly other applications in a system may let the user select a preferred search service provider among multiple search service providers and use the user selected search service provider to delegate the search operation performed from within the application.

There may be several applications installed in a system and configuring the preferred search service provider in each and every one of these applications is a tedious process. Further, if the user wants to change the preferred search service provider at a later stage, he is required to change the configuration across all the applications. For example, if the user prefers “Google” as the search service in all the applications, in order to achieve this, the user has to change the search service provider settings to “Google” in all the applications within the system. This is a tedious process. Also, if the user is not satisfied with “Google” and wants to change to his original search service provider or to a new search service provider, he has to again manually change the settings in all the applications.

In view of the above drawbacks, there remains a need for a system and method for configuring a preferred search service and sharing the preferred search service across one or more applications installed in a system.

### SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

A method of providing search setting in a system, the method comprising (a) providing a search setting adapted to provide search engine setting functionality; said search setting comprising a plurality of search engine setting to select from (b) selecting at least one search engine setting; such that the selected search engine setting is applicable to at least two applications in said system.

In one embodiment, the system may be operating system.

### BRIEF DESCRIPTION OF THE DRAWINGS

The drawings described herein are for illustration purposes only and are not intended to limit the scope of the present disclosure in anyway. Throughout the disclosure, like elements are represented by like reference numerals, which are given by way of illustration only and thus are not limitative of the various embodiments.

Other objects and advantages of the present disclosure will become apparent to those skilled in the art upon reading the following detailed description of the preferred embodiments, in conjunction with the accompanying drawings, wherein:

FIG. 1 is a block diagram illustrating a system for configuring and sharing search settings in accordance with an embodiment of the present disclosure.

FIG. 2 is a block diagram of an exemplary computing device of FIG. 1.

FIG. 3 is an exemplary interface provided to the user to configure search settings by the client of FIG. 1.

FIG. 4 depicts a portion of a browser showing a search operation being performed by the configured preferred search engine.

FIG. 5 depicts a portion of an application showing a search operation being performed by the configured preferred search engine.

FIG. 6 is a flow diagram of a method of configuring and sharing the preferred search service provider, in accordance with one or more preferred embodiments.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Through the length of the specification and claims, the words “search service” and “search engine” are used interchangeably.

Through the length of the specification and claims, the words “setting” and “option” are used interchangeably.

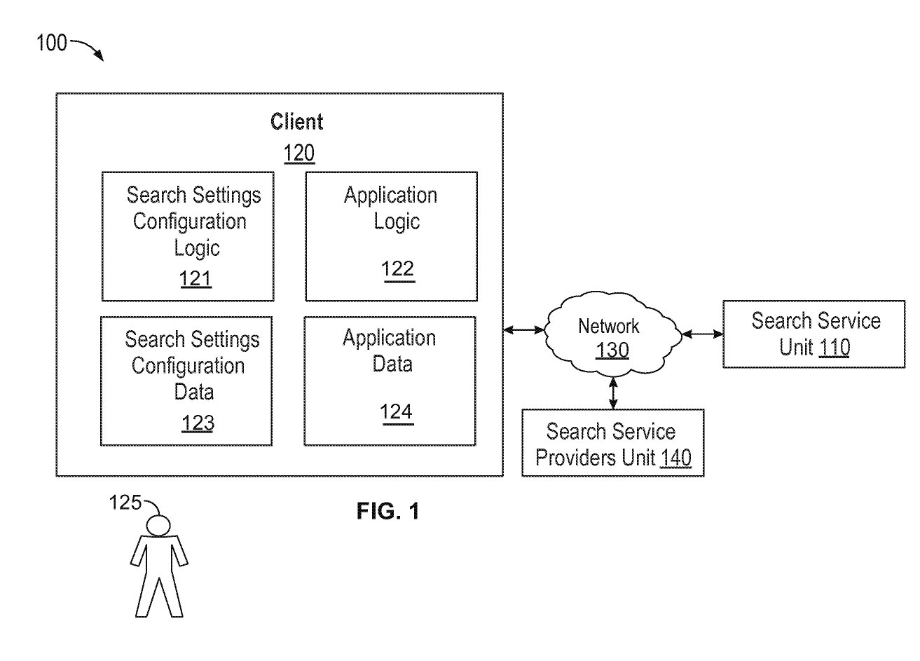

FIG. 1 depicts a system for configuring and sharing search settings in accordance with an embodiment of the present disclosure. It will be understood and appreciated by those of ordinary skill in the art that the system architecture 100 shown in FIG. 1 is merely an example of one suitable computing system and is not intended to suggest any limitation as to the scope of use or functionality of the present disclosure. Neither should the computing system architecture 100 be interpreted as having any dependency or requirement related to any single module/component or combination of modules/components illustrated therein.

The system 100 comprises a search service unit 110, a client 120 and a search service providers unit 140. The search service unit 110, the client 120 and the search service providers unit 140 all communicate over a network 130.

The network 130 can include any type of network known in the art or future-developed. In this regard, the network 130 may be an Ethernet, a local area network (LAN), or a wide area network (WAN), e.g., the Internet, or a combination of networks.

The search service unit 110, the client 120, and the search service providers unit 140 may be, but are not limited to, a computer, handheld unit, mobile unit, consumer electronic unit, or the like. For simplicity sake only one search service unit 110 and only one search service providers unit 140 are shown in FIG. 1. In practice there may be multiple search service unit 110 and multiple search service providers unit 140.

The client 120 comprises of search settings configuration logic 121 and application logic 122, along with search settings configuration data 123 and application data 124.

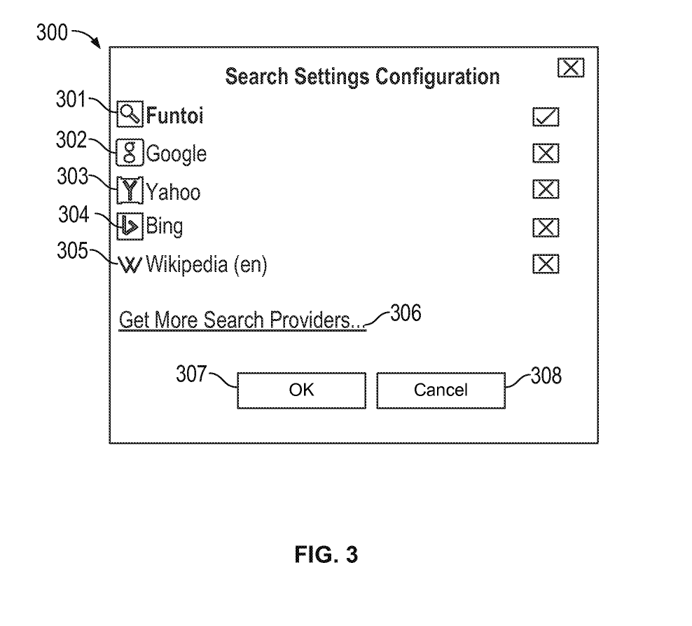

The search settings configuration logic 121 through an interface allows the user 125 to configure search settings. Such settings may include specifying the preferred search service. The settings configured by the user 125 are stored in the search settings configuration data 123 by the search settings configuration logic 121. The search settings configuration logic 121 is further explained with respect to FIG. 3.

In one embodiment, if a user 125 intends to perform a search operation from within the application logic 122, the application logic 122 queries the search settings stored in the search settings configuration data 123 and performs the search operation using the settings retrieved from the search settings configuration data 123.

In another embodiment, if a user 125 intends to perform a search operation from within the application logic 122, the application logic 122 queries the search settings stored in the search settings configuration data 123 through the search settings configuration logic 121 and performs the search operation using the settings retrieved from the search settings configuration data 123.

In yet another embodiment, the application logic 122 may provide an interface to specify search settings which are then stored in the application data 124 by the application logic 122. When a search operation is performed from within the application logic 122, the application logic 122 first checks if the application data 124 contains search settings. If so, the application logic 122 uses the search settings in the application data 124. If the search settings are missing in application data 124, the application logic 122 uses the search settings from search settings configuration data 123.

For simplicity sake only one application logic 121 and one application data 122 are shown in the client 120. In practice there may be multiple application logics installed/running on the client 120.

The application logic 122, may be, but not limited to, email applications, browser applications, word processors, office software suites, viewer(s), development tools, apps, applications, applets, or any other logic that will provide functionality and interface with the user 125.

Further, the configuration settings that may be provided to the user 125 by the search settings configuration logic 121 may be augmented. In this regard the system 100 further consists of search service providers unit 140. For example, if the user 125 desired search service is not in the list, the search settings configuration logic 121 may first contact the search service providers unit 140 to get an updated list of search services and presents the list to the user 125 to select from. The search service providers unit 140 is further explained with respect to FIG. 3.

In one embodiment, the search engine configuration logic 121 may be part of the operating system (not shown) of the client 120.

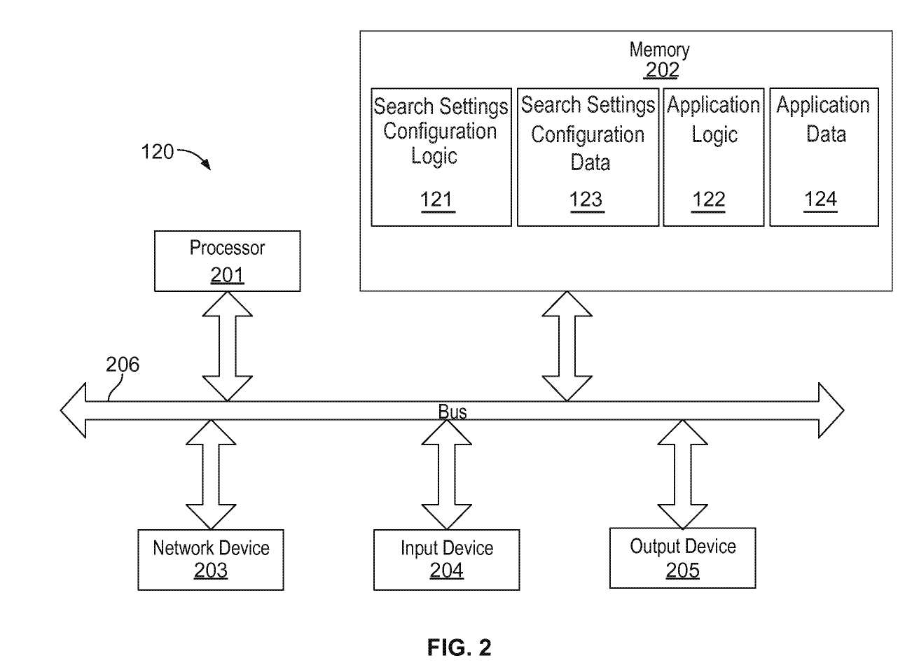

In some preferred embodiments, the client 120 is shown in FIG. 2. It should be noted, however, that embodiments are not limited to implementation on such computing devices, but may be implemented on any of a variety of different types of computing units within the scope of embodiments hereof. The client 120 (as shown in FIG. 1) is only one example of a suitable computing/search environment and it is not intended to suggest any limitation as to the scope of use or functionality of the disclosure.

In some embodiments, the client 120 may include a bus 206, a processor 201, memory 202, network device 203, input device 204, and an output device 205. Bus 206 may include a path that permits communication among the components of the client 120.

The search settings configuration logic 121, search settings configuration data 123, application logic 122 and application data 124 may be stored as software in memory 202.

The memory 202 may be any type of computer memory known in the art or future-developed for electronically storing data and/or logic, including volatile and non-volatile memory. In this regard, memory 202 can include random access memory (RAM), read-only memory (ROM), flash memory, any magnetic computer storage unit, including hard disks, floppy discs, or magnetic tapes, and optical discs.

The processor 201 comprises processing hardware for interpreting or executing tasks or instructions stored in memory 202. Note that the processor 201 may be a microprocessor, a digital processor, or other type of circuitry configured to run and/or execute instructions.

The network device 203 may be any type of network unit (e.g., a modem) known in the art or future-developed for communicating over a network 130 (FIG. 1). In this regard, the client 120 (FIG. 1) communicates with the search service providers unit 140 (FIG. 1) and the search service unit 110 (FIG. 1) over the network 130 (FIG. 1) via the network device 203.

The input device 204 is any type of input unit known in the art or future-developed for receiving data. As an example, the input unit 204 may be a keyboard, a mouse, a touch screen, a serial port, a scanner, a camera, or a microphone.

The output device 205 may be any type of output unit known in the art or future-developed for displaying or outputting data. As an example, the output device 205 may be a liquid crystal display (LCD) or other type of video display unit, a speaker, or a printer.

FIG. 3 is an exemplary user interface 300 displayed by the search settings configuration logic 121 (FIG. 1) to the user 125 (FIG. 1) in order to set the search settings that can be shared across multiple applications. In the interface 300, the user may select his preferred search service setting from the list 301-305. In the exemplary interface 300, the user selected “Funtoi” 301 as his preferred search service. If the user 125 (FIG. 1) doesn't like the choices 301-305, the user 125 (FIG. 1) may select “Get More Search Providers . . .” 306 and the search settings configuration logic 121 (FIG. 1) may augment the list 301-305 with additional search engines retrieved from the search service providers unit 140 (FIG. 1). Once the user 125 (FIG. 1) selected the desired settings, he may select “OK” 307 to save the settings in the search settings configuration data 123 (FIG. 1) and other applications running in the system may use the settings saved in the search settings configuration data 123 (FIG. 1).

Note that in other embodiments, further settings that are associated and/or unique to selected search engine may be configured with user interface 300. These settings may be provided to the user 125 (FIG. 1) within the user interface 300 (not shown) or in a window (not shown) upon selection of a preferred search engine. For example, the user 125 may specify the number of maximum results that that a search engine may return.

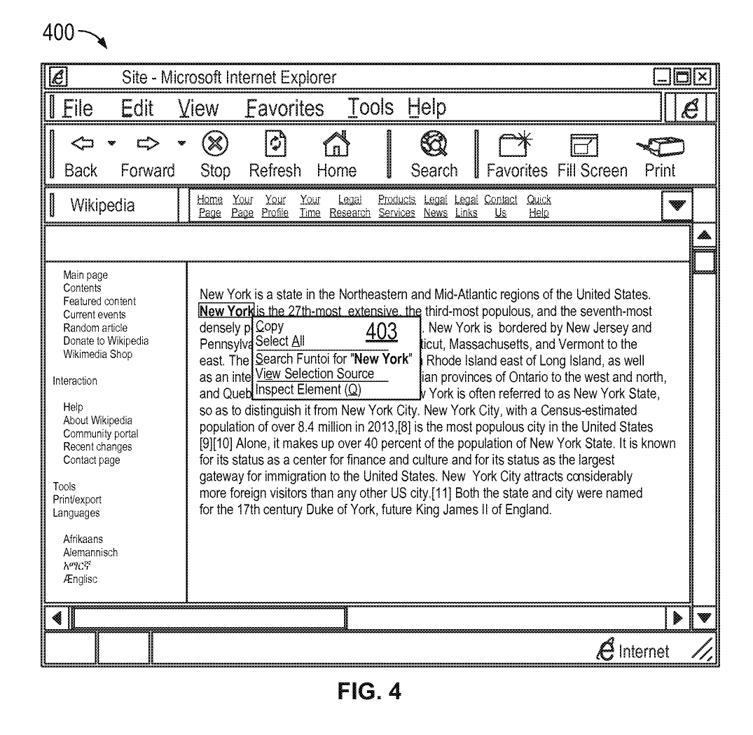

FIG. 4 depicts a portion of browser application 400 showing a search operation being performed by the configured preferred search engine. Assume that the user set “Funtoi” as his preferred search engine using the interface shown in FIG. 3. On selecting the keyword “New York”, the application queries the search settings configuration data 123 (FIG. 1) and displays an option “Search Funtoi for “New York” represented by 403. While the user 125 (FIG. 1) selects the option 403, the “Funtoi”” search engine is invoked and search results for the words “New York” returned by “Funtoi” may be displayed to the user 125 (FIG. 1).

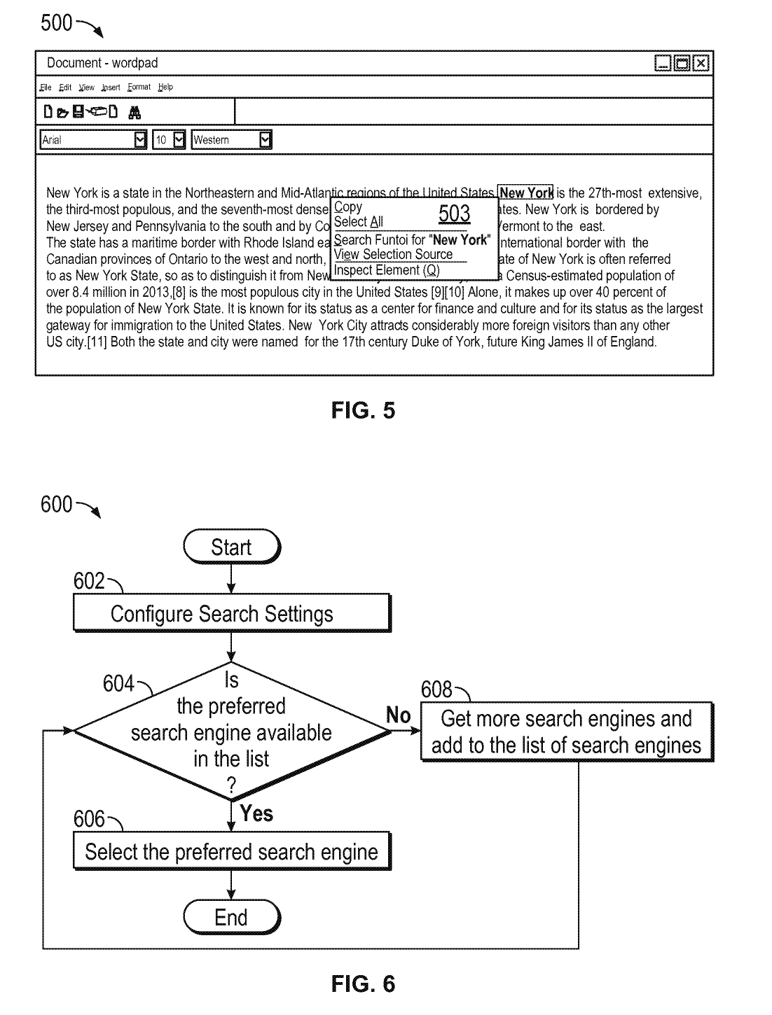

FIG. 5 depicts a portion of word processor application 500 showing a search operation being performed by the configured preferred search engine. Assume that the user set “Funtoi” as his preferred search engine using the interface shown in FIG. 3. On selecting the keyword “New York”, the application queries the search settings configuration data 123 (FIG. 1) and displays an option “Search Funtoi for “New York”” represented by 503. While the user 125 (FIG. 1) selects the option 503, the “Funtoi” search engine is invoked and search results for the words “New York” returned by “Funtoi” may be displayed to the user 125 (FIG. 1).

FIG. 6 is a flow chart 600 illustrating one method in accordance with present disclosure. In step 602, the user is allowed to configure the search options for the one or more applications 122 (FIG. 1) by the search settings configuration logic 121 (FIG. 1). While configuring the search settings, in step 604 the user 125 (FIG. 1) verifies if the preferred search engine is available in the list presented by the search settings configuration logic 121 (FIG. 1) in the interface 300 (FIG. 3). If the preferred search engine is available in the list, at step 606 the user 125 (FIG. 1) selects the preferred search engine as the preferred search engine for the application logic 122 (FIG. 1). If the preferred search engine is not available in the list, at step 608 the search settings configuration logic 121 (FIG. 1) may add more search engines to the list from an updated list of search engines from the search service providers unit 140 (FIG. 1).

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method of providing a search setting in a system, said method comprising
(a) providing a search setting adapted to provide search engine setting functionality; said search setting comprising a plurality of search engine setting to select from (b) selecting at least one search engine setting; such that the selected search engine setting is applicable to at least two applications in said system.

2. A method as in claim 1, wherein the system comprises a software.

3. A method as in claim 2, wherein the software is an operating system.

4. A system comprising a search setting adapted to provide search engine setting functionality; said search setting comprising a plurality of search engine setting to select from such that the selected search engine setting is applicable to at least two applications in said system.

5. A system as in claim 4 comprising a software.

6. A system as in claim 5 wherein the software is an operating system.
